(19) United States
(12) Patent Application Publication
(10) Pub. No.: US 2021/0296994 A1
(43) Pub. Date: Sep. 23, 2021

(54) CIRCUIT FOR CONTROLLING FLICKERING AND METHOD THEREFOR

(71) Applicant: SEMICONDUCTOR COMPONENTS INDUSTRIES, LLC, Phoenix, AZ (US)

(72) Inventors: Jintae KIM, Seongnam-si (KR); JooHoon KIM, Bucheon (KR); Moonsik SONG, Bucheon (KR)

(73) Assignee: SEMICONDUCTOR COMPONENTS INDUSTRIES, LLC, Phoenix, AZ (US)

(21) Appl. No.: 16/820,981

(22) Filed: Mar. 17, 2020

(51) Int. Cl. H02M 3/335; H02M 3/156; G05F 1/46

(52) U.S. Cl. CPC H02M 3/33507; H02M 2001/0009; G05F 1/465; H02M 3/156

(57) ABSTRACT

A controller for a power converter includes a first input node receiving a sensing signal that indicates an output signal of the power converter, a second input node receiving an external signal that indicates a target value for a load, and a feedback signal generator generating a first feedback signal in response to the sensing signal and the external signal. The feedback signal generator uses a first feedback path with a first gain value when the power converter operates in a first mode and uses a second feedback path when the power converter operates in a second mode. The feedback signal generator includes a gain adjusting circuit configured to decrease a gain value of the second feedback path from the first gain value to a second gain value at a plurality of times when the power converter operates in the second mode

### BACKGROUND

The present disclosure relates to a controller, a power converter including the controller, and a method for controlling the power converter.

A power converter converts an input voltage into an output voltage and provides an output signal to a load. For example, the power converter may provide an output current to one or more light emitting diode (LED) strings each including a plurality of LEDs and adjust a magnitude of a current flowing through the LEDs to obtain a desirable level of brightness. When an overshoot of the current flowing through the LEDs occurs, the overshoot may produce a brief interval during which light emitted from the LEDs is undesirably bright, such as by producing a flash of light. Subsequently, when the current flowing through the LEDs decreases at a rate greater than a certain value, this change may produce a flickering of light.

### SUMMARY

Embodiments of the present application relate to a controller, a power converter including the controller, and a method for controlling the power converter.

In an embodiment, a controller for a power converter includes a first input node receiving a sensing signal that indicates an output signal of the power converter, a second input node receiving an external signal that indicates a target value for a load, and a feedback signal generator generating a first feedback signal in response to the sensing signal and the external signal. The feedback signal generator uses a first feedback path with a first gain value when the power converter operates in a first mode and uses a second feedback path when the power converter operates in a second mode. The feedback signal generator includes a gain adjusting circuit configured to decrease a gain value of the second feedback path from the first gain value to a second gain value at a plurality of times when the power converter operates in the second mode.

In an embodiment, a power converter includes a first side including a first controller and a first portion of an opto-coupler, the first controller controlling a switching operation of a switching device, and a second side including a second controller and a second portion of the opto-coupler. The second controller includes a feedback signal generator configured to generate a first feedback signal in response to a sensing signal and an external signal, the sensing signal indicting an output signal of the power converter, the external signal indicating a target value for a load. The feedback signal generator uses a first feedback path with a first gain value when the power converter operates in a first mode and uses a second feedback path when the power converter operates in a second mode. The feedback signal generator includes a gain adjusting circuit configured to decrease a gain value of the second feedback path from the first gain value to a second gain value at a plurality of times when the power converter operates in the second mode. The second controller further includes a buffer configured to generate an opto-coupler signal in response to the first feedback signal and provide the opto-coupler signal to the second portion of the opto-coupler.

In an embodiment, a method for controlling a power converter includes generating a first feedback signal in response to a sensing signal and an external signal by a feedback signal generator, the feedback signal generator using a first feedback path with a first gain value when the power converter operates in a first mode and using a second feedback path when the power converter operates in a second mode. The sensing signal indicates an output signal of the power converter, and the external signal indicates a target value for a load. The method further includes decreasing a gain value of the second feedback path from the first gain value to a second gain value at a plurality of times when the power converter operates in the second mode.

### BRIEF DESCRIPTION OF THE DRAWINGS

FIG. 1 illustrates a power converter according to an embodiment of the present disclosure.

FIG. 2 illustrates a flyback converter according to an embodiment of the present disclosure.

FIG. 3 illustrates a controller according to an embodiment of the present disclosure.

FIG. 4 illustrates a gain adjusting circuit according to an embodiment of the present disclosure.

FIG. 5 illustrates an operation of the controller in FIG. 3 according to an embodiment of the present disclosure.

FIG. 6 illustrates a process performed by the controller in FIG. 3 according to an embodiment.

### DETAILED DESCRIPTION

Embodiments of the present application relate to a controller for controlling a power converter, a power converter including the controller, and a method for controlling the power converter.

In an embodiment, a controller includes a feedback signal generator using a first feedback path with a first gain value when the power converter operates in a first mode (e.g., a startup mode or a low-gain mode) and using a second feedback path when the power converter operates in a second mode (e.g., a gain adjusting mode). The feedback signal generator includes a gain adjusting circuit that decreases a gain value of the second feedback path from the first gain value to a second gain value at a plurality of times when the power converter operates in the gain adjusting mode. As a result, a power converter including the controller according to an embodiment may prevent an overshoot of a string current, or a flickering, or both when the power converter operates in the gain adjusting mode.

In an embodiment, the feedback signal generator further includes a voltage copier circuit that is coupled to the gain adjusting circuit at a specific node. The voltage copier circuit generates a second feedback signal in response to the first feedback signal and provide the second feedback signal to the node when the power converter operates in the gain adjusting mode. As a result, a power converter including the controller according to an embodiment may suppress fluctuations in the first feedback signal when the gain value of the second feedback path decreases at the plurality of times.

In an embodiment, the first feedback path of the feedback signal generator includes an amplifier and a capacitor having a relatively small capacitance value when the power operates in the startup mode. As a result, the first feedback path has a relatively high gain value and a relatively high response speed. Accordingly, a power converter including the controller according to an embodiment may prevent an overshoot of a string current, or a flickering, or both when the power converter operates in the startup mode.

A detailed description of embodiments is provided below along with accompanying figures. The scope of this disclosure is limited only by the claims and encompasses numerous alternatives, modifications and equivalents. Although steps of various processes are presented in a given order, embodiments are not necessarily limited to being performed in the listed order. In some embodiments, certain operations may be performed simultaneously, in an order other than the described order, or not performed at all.

Numerous specific details are set forth in the following description. These details are provided to promote a thorough understanding of the scope of this disclosure by way of specific examples, and embodiments may be practiced according to the claims without some of these specific details. Accordingly, the specific embodiments of this disclosure are illustrative, and are not intended to be exclusive or limiting. For the purpose of clarity, technical material that is known in the technical fields related to this disclosure has not been described in detail so that the disclosure is not unnecessarily obscured.

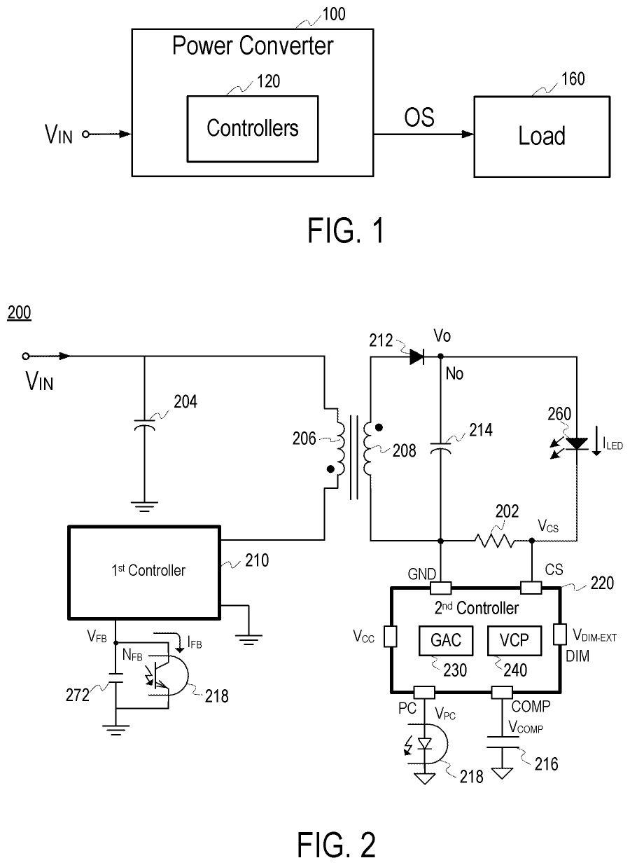

FIG. 1 illustrates a power converter 100 according to an embodiment of the present disclosure. The power converter 100 receives an input signal (e.g., an input voltage) V_{IN} and provides an output signal (e.g., an output voltage or an output current) OS to a load 160.

The power converter 100 may adjust a value of the output signal OS using a feedback control based on information on the output signal OS and a target value for the load 160. In an embodiment, the power converter 100 may be a flyback converter.

The power converter 100 may be controlled by one or more controllers 120. In an embodiment, a first one of the controllers 120 is disposed on a first side (e.g., a primary side) and controls a switching operation of a switching device. In such an embodiment, a second one of the controllers 120 is disposed on a second side (e.g., a secondary side) and performs a feedback operation in response to a sensing signal (e.g., a sensing signal V_{CS} in FIG. 2) indicative of a current (e.g., a string current I_{LED} in FIG. 2) flowing through the load 160 (e.g., an LED string 260 in FIG. 2) and an external signal (e.g., an external dimming signal V_{DIM_EXT} in FIG. 2) indicative of a target value (e.g., a brightness level) for the load 160. For example, the second one of the controllers 120 may include a gain adjusting circuit (e.g., a gain adjusting circuit 230 in FIG. 2) that gradually adjusts a gain value of a feedback path when the power converter 100 operates in a specific mode (e.g., a gain adjusting mode).

The controllers 120 may be integrated in one or more semiconductor chips. These semiconductor chips may be packaged by themselves or together with one or more other semiconductor chips.

The load 160 may include one or more integrated chips (ICs). In an embodiment, the output signal OS is used to supply power to one or more of a Central Processing Unit (CPU), a Graphics Processing Unit (GPU), an integrated memory circuit, a battery charger, a light emitting diode (LED), or other types of electrical load.

FIG. 2 illustrates a power converter (e.g., a flyback converter) 200 according to an embodiment of the present disclosure. In an embodiment, the flyback converter 200 is a single-stage flyback converter that converts an AC input signal into a DC output signal. For example, the flyback converter 200 in FIG. 2 receives an input signal (e.g., an input voltage) V_{IN} that is a rectified version of the AC input signal provided by an AC power supply (not shown) and converts the input signal V_{IN} into the DC output signal (e.g., an output voltage) to provide the DC output signal Vₒ to an LED string 260.

A first side (e.g., a primary side) of the flyback converter 200 includes a first controller (e.g., a primary side controller) 210, a first capacitor 204, a primary coil 206, a second capacitor 272, and a first portion of an opto-coupler 218. In an embodiment, the first controller 210 includes a switch device (not shown) and generates a drive signal (not shown) to turn on or off the switch device. For example, during a first portion (e.g., an on-time duration) of a cycle of the drive signal, the first controller 210 turns on the switch device. This causes energy to be supplied from the input voltage V_{IN} to the primary coil 206, where it is stored as a magnetic flux. During the remaining portion (e.g., an off-time duration) of the cycle of the drive signal, the first controller 210 turns off the switch device. In response, the energy stored in the primary coil 206 is transferred into a secondary coil 208, causing a current to flow in the secondary coil 208 and a voltage to develop across end terminals of the secondary coil 208. In the above-described embodiment, the first controller 210 includes the switch device, but embodiments of the present disclosure are not limited thereto. For example, the switch device may be disposed outside the first controller 210.

The primary side controller 210 may further include a Power Factor Correction (PFC) circuit (not shown), which performs a PFC operation to present a PF close to 1 (e.g., 0.98) to the AC power supply by keeping the phase of a current drawn from the AC power supply close to the phase of the voltage of the AC power supply.

The second capacitor 272 has a first end coupled to a first node N_{FB} and a second end coupled to a ground. The first portion of the opto-coupler 218 is coupled to the second capacitor 272 in parallel.

A second side (e.g., a secondary side) of the flyback converter 200 includes the secondary coil 208, a diode 212, an output capacitor 214, a sensing resistor 202, a second controller (e.g., a secondary side controller) 220, a second portion of the opto-coupler 218, and a third capacitor 216.

The diode 212 has a cathode coupled to a first end of the output capacitor 214 at an output node No. A second end of the output capacitor 214 is coupled to a ground.

The LED string 260 is coupled between the output node No and the sensing resistor 202. The LED string 260 includes one or more LEDs coupled to together either in series, in parallel, or in combinations thereof. Each of the plurality of LEDs converts a current passing the LED into light. A brightness of light emitted by the LEDs varies with a magnitude of the current flowing through the LED string 260. Although the LED string 260 shown in FIG. 2 is a single string that includes a plurality of LEDs coupled in series, embodiments of the present disclosure are not limited thereto. For example, the LED string 260 may include two or more strings coupled in parallel, for example, three strings, each of which includes a plurality of LEDs that are coupled in series.

The sensing resistor 202 generates a sensing signal V_{CS} based on a string current I_{LED} flowing through the LED string 260. For example, the sensing resistor 202 may have a first end coupled to the LED string 260 and a second end coupled to the ground, and generate the sensing signal V_{CS} having a value proportional to the magnitude of the string current I_{LED} flowing through the LED string 260.

The secondary side controller 220 receives the sensing signal V_{CS} and an external dimming signal V_{DIM_EXT} and provides a feedback detection signal (e.g., an opto-coupler signal) V_{PC} to the second portion of the opto-coupler 218. The second portion of the opto-coupler 218 recieves the opto-coupler signal V_{PC} and converts the received opto-coupler signal V_{PC} into light. For example, the second portion of the opto-coupler 218 includes a light-emitting diode (LED).

The first portion of the opto-coupler 218, which is included in the primary side of the flyback converter 200, detects the converted light and adjusts an amount of a feedback current I_{FB} flowing through the first portion of the opto-coupler 218 in response to the detected light. For example, when a value of the opto-coupler signal V_{PC} decreases, the amount of light converted by the second portion of the opto-coupler 218 is reduced to decrese the mangitude of the feedback current I_{FB}. Because a substantially constant current flows from the primary side controller 210 into the first node N_{FB}, when the feedback current I_{FB} flowing from the first node N_{FB} into the first portion of the opto-coupler 218 decreases, a current flowing from the first node N_{FB} into the second capacitor 272 increases. As a result, a feedback voltage V_{FB} at the first end of the second capacitor 272 increases, and the primary side controller 210 may adjust a duty cycle of the switching device based on the feedback voltage V_{FB}.

The secondary side controller (SSC) 220 includes a gain adjusting circuit 230 that gradually adjusts its gain value when the power converter 200 operates in a specific mode. In an embodiment, the gain adjusting circuit 230 adjusts a gain value of a feedback path included in the SSC 220 from a first value to a second value at a plurality of times, rather than changing the gain value from the first value to the second value at once, when the power converter 200 operates in a gain adjusting mode.

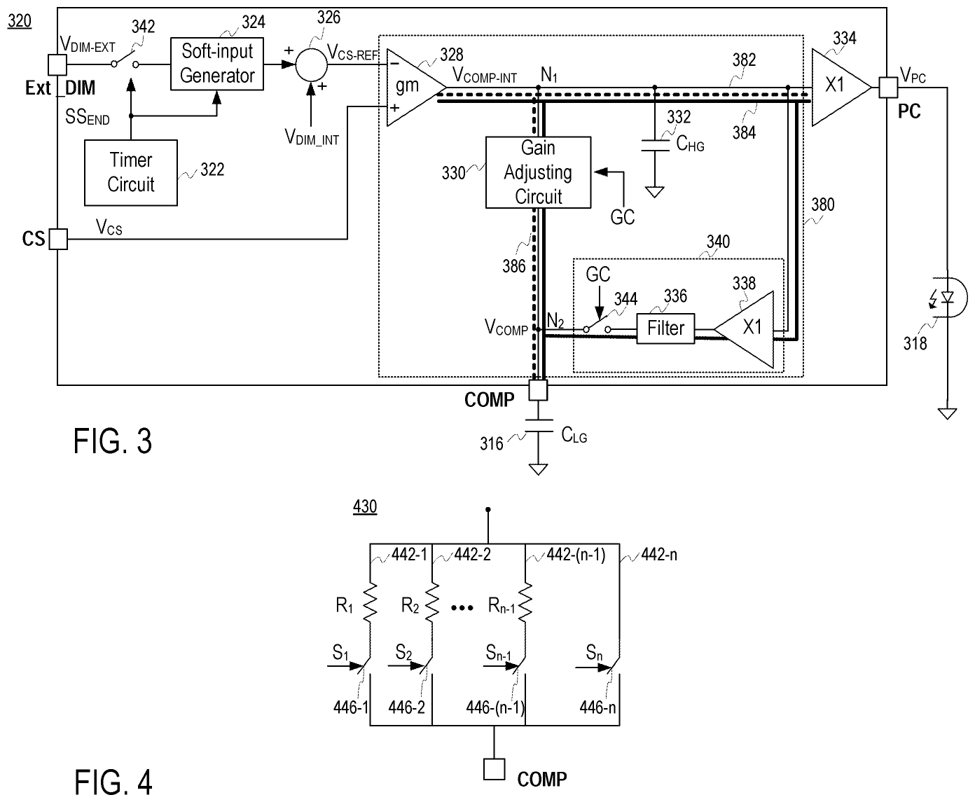

The secondary side controller (SSC) 220 generates a reference signal (e.g., a reference signal V_{CS_REF} in FIG. 3) in response to the external dimming signal V_{DIM_EXT} and an internal dimming signal (e.g., an internal dimming signal V_{DIM_INT} in FIG. 3), and generates a first feedback signal (e.g., a first feedback signal V_{COMP_INT} in FIG. 3) in response to the sensing signal V_{CS} and the reference signal. The SSC 220 further includes a voltage copier circuit 240 that generates a second feedback signal V_{COMP} in response to the first feedback signal and provides the second feedback signal V_{COMP} to the third capacitor 216, when the power converter 200 operates in a specific mode. In an embodiment, the voltage copier circuit 240 copies the first feedback signal and provides an averaged version of the copied first feedback signal to the third capacitor 216 as the second feedback signal V_{COMP}, when the power converter 200 operates in the gain adjusting mode.

FIG. 3 illustrates a secondary-side controller (SSC) 320 according to an embodiment of the present disclosure. In FIG. 3, the SSC 320 includes a timer circuit 322, a first switching device 342, a soft-input generator 324, an arithmetic circuit 326, a feedback signal generator 380, a first buffer 334, and a portion of an opto-coupler 318. In an embodiment, the feedback signal generator 380 includes an amplifier 328, a first node N₁, a gain adjusting circuit 330, a voltage copier circuit 340, a first capacitor 332, and a second node N₂ coupled to a second capacitor 316.

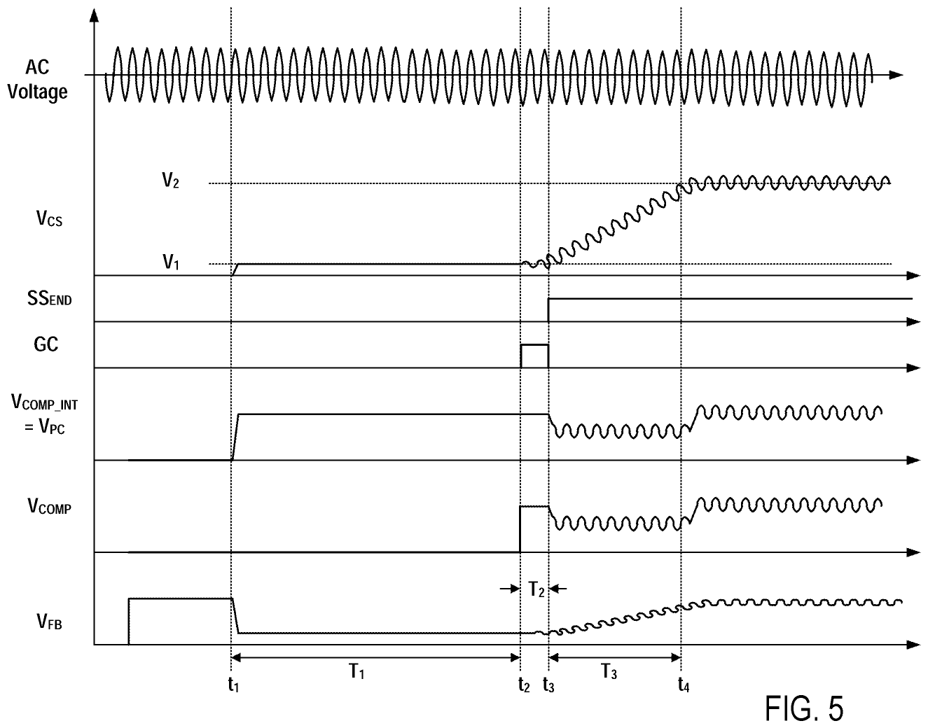

The timer circuit 322 generates a soft-start end signal SS_{END} and provides the soft-start end signal SS_{END} to the first switching device 342. In an embodiment, the timer circuit 322 asserts the soft-start end signal SS_{END} a given time interval (e.g., a few hundred milliseconds) after a power converter including the SSC 320 has started to operate in a start-up mode, and provides the asserted soft-start end signal SS_{END} to turn on the first switching device 342. For example, the timer circuit 322 includes a counter circuit including a T Flip-flop, the counter circuit starting to increase its value when the power converter starts to operate in the start-up mode and asserting the soft-start end signal SS_{END} at a specific time (e.g., a third time t₃ in FIG. 5) when the value reaches a given value.

When the first switching device 342 is turned on in response to the asserted soft-start end signal SS_{END}, the soft-input generator 324 receives an external dimming signal V_{DIM_EXT} through a first input node (e.g., a dimming pin) Ext_DIM and generates an output signal in response to the external dimming signal V_{DIM_EXT}. In an embodiment, the soft-input generator 324 gradually increases a value of the output signal until the value of the output signal reaches a given value corresponding to that of the external dimming signal V_{DIM_INT}. For example, the soft-input generator 324 includes a resistor and a capacitor coupled in series to each other and generates the output signal at a node between the resistor and the capacitor.

The arithmetic circuit 326 receives the external dimming signal V_{DIM_EXT} and an internal dimming signal V_{DIM_INT} and performs an arithmetic operation to generate a reference signal V_{CS_REF}. In an embodiment the arithmetic circuit 326 is an adder circuit.

The feedback signal generator 380 generates the first feedback signal V_{COMP_INT} in response to the reference signal (e.g., a reference voltage) V_{CS_REF} and a sensing signal (e.g., a sensing voltage) V_{CS}. The feedback signal generator 380 uses a first feedback path 382 when the power converter operates in a first mode (e.g., a startup mode or a low-gain mode), the first feedback path 382 including the amplifier 328 and the first capacitor 332. The feedback signal generator 380 uses a second feedback path 384 when the power converter operates in a second mode (e.g., a gain adjusting mode), the second feedback path 384 including the amplifier 328, the first capacitor 332, the gain adjusting circuit 330, the voltage copier circuit 340, and a second node N₂ coupled to the second capacitor 316. The feedback signal generator 380 uses a third feedback path 386 when the power converter operates in a third mode (e.g., a high-gain mode), the third feedback path 386 including the amplifier 328, the first capacitor 332, the gain adjusting circuit 330, and the second node N₂ coupled to the second capacitor 316.

The amplifier 328 of the feedback signal generator 380 receives the reference signal V_{CS_REF} and the sensing signal V_{CS} and generates a first feedback signal V_{COMP_INT} indicating a difference between values of the reference signal V_{CS_REF} and the sensing signal V_{CS}. For example, the amplifier 328 receives the sensing signal V_{CS} through a second input node (e.g., a sensing pin) CS. In an embodiment, the amplifier 328 is a transconductance amplifier and generates a current having a magnitude that is proportional to a difference between levels of the reference voltage V_{CS_REF} and the sensing voltage V_{CS}.

The gain adjusting circuit 330 adjusts a gain value of the second feedback path 384 of the SSC 320 at a plurality of times when the power converter operates in the gain adjusting mode. In an embodiment, the gain adjusting circuit 330 decreases its total resistance value a given number of times to decrease the gain value of the second feedback path 384. For example, the gain adjusting circuit 330 may include a plurality of parallel paths, one of the plurality of paths including a first switching element, the remaining ones of the plurality of paths including a second plurality of switching elements and a plurality of resistors, each of the second plurality of switching elements being coupled to a respective one of the plurality of resistors in series, and the second plurality of switching elements and the first switching element of the gain adjusting circuit 330 may be sequentially turned on to decrease a total resistance value of the gain adjusting circuit 330.

The voltage copier circuit 340 receives the first feedback signal V_{COMP_INT} and generates a second feedback signal V_{COMP} in response to the first feedback signal V_{COMP_INT}. In an embodiment, the voltage copier circuit 340 copies the first feedback signal V_{COMP_INT} and provides an averaged version of the first feedback signal V_{COMP_INT} to a second node N2 as the second feedback signal V_{COMP}, when the power converter operates in the gain adjusting mode. For example, the voltage copier circuit 340 includes a second switching device 344, a second buffer 338 and a filter 336.

The first capacitor 332 has a capacitance value that is relatively small. In an embodiment, the capacitance value of the first capacitor 332 is equal to or less than 10 pF. As a result, the first feedback path 382 including the transconductance amplifier 328 and the first capacitor 332 may have a relatively high gain value, leading to a relatively fast response speed.

The second capacitor 316 has a capacitance value that is significantly greater than that of the first capacitor 332. In an embodiment, the capacitance value of the second capacitor 316 is at least 10000 times greater than that of the first capacitor 332. For example, the capacitance value of the second capacitor 316 is in a range from 100 nF to 5 μf. As a result, the third feedback path 386 including the transconductance amplifier 328, the first capacitor 332, the gain adjusting circuit 330, and the second node N₂ coupled to the second capacitor 316 may have a relatively low gain value, leading to a relatively low response speed suitable for performing power factor correction.

The first buffer 334 generates a feedback detection signal (e.g., an opto-coupler signal) V_{PC} in response to the first feedback signal V_{COMP_INT}. In an embodiment, the first buffer 334 has a unity gain and generates the opto-coupler signal V_{PC} having substantially the same value as that of the first feedback signal V_{COMP_INT}.

The portion of the opto-coupler 318 receives the opto-coupler signal V_{PC} and converts the received opto-coupler signal V_{PC} into light. In an embodiment, the first portion of the opto-coupler 318 includes light-emitting diode (LED).

FIG. 4 illustrates a gain adjusting circuit 430 suitable for use as the gain adjusting circuit 330 in FIG. 3 according to an embodiment of the present disclosure. The gain adjusting circuit 430 gradually adjusts its total resistance value in response to a plurality of switching signals S₁ to Sₙ.

The gain adjusting circuit 430 includes a plurality of parallel paths 442-1 to 442-n. First to (n−1)^{th} paths 442-1 to 442-(n−1) include a plurality of resistors R₁ to Rₙ₋₁ and first to (n−1)^{th} switching elements 446-1 to 446-(n−1), respectively, and an n^{th} path 442-n includes an n^{th} switching element 446-n. In an embodiment, the number of the plurality of parallel paths 442-1 to 442-n are in a range from 4 to 40, or from 12 to 32. For example, the number n of the plurality of parallel paths 442-1 to 442-n is twelve, and the resistance values of the plurality of resistors R₁ to R₁₁ are 10 MΩ, 1 MΩ, 500 KΩ, 300 KΩ, 100 KΩ, 50 KΩ, 30 KΩ, 10 KΩ, 3 KΩ, 1 KΩ, and 500Ω, respectively.

The plurality of switching elements 446-1 to 446-n may be turned on sequentially in response to the plurality of switching signals S₁ to Sₙ, thereby decreasing the total resistance value of the gain adjusting circuit 430. In an embodiment, a demultiplexer (not shown) provides the plurality of switching signals S₁ to Sₙ to the switching elements 446-1 to 446-n, respectively, at regular time intervals when a power converter (e.g., the flyback converter 200 in FIG. 2) operates in the gain adjusting mode, to sequentially turn on the switching elements 446-1 to 446-n, thereby decreasing the total resistance value of the gain adjusting circuit 430.

An operation of the SSC 320 in FIG. 3 will be described below in more detail with reference to FIGS. 3, 4, and 5 according to an embodiment.

Referring to FIGS. 3 and 5, at a first time t₁, a power converter (e.g., the flyback converter 200 in FIG. 2) including the SSC 320 starts to operate in a first mode (e.g., a startup mode or a high-gain mode), and the arithmetic circuit 326 receives the internal dimming signal V_{DIM_INT} and outputs the reference signal V_{CS_REF} having a value that is substantially equal to that of the internal dimming signal V_{DIM_INT}. In an embodiment, the internal dimming signal V_{DIM_INT} may indicate a given dimming level suitable for use in the startup mode. For example, the internal dimming signal V_{DIM_INT} may have a value corresponding to a dimming level of about 1%.

A string current (e.g., the string current I_{LED} in FIG. 2) flowing through an LED string (e.g., the LED string 260 in FIG. 2) increases in response to the internal dimming signal V_{DIM_INT}, and thus the sensing signal V_{CS} also increases up to a first value V₁ corresponding to the value of the internal dimming signal V_{DIM_INT}. When the sensing signal V_{CS} increases and the reference signal V_{CS_REF} is kept at a substantially constant value, the transconductance amplifier 328 generates an output current having a magnitude that is proportional to a difference between values of the sensing signal V_{CS} and the reference signal V_{CS_REF}. The output current from the transconductance amplifier 328 flows into the first capacitor 332 to charge the first capacitor 332, thereby increasing the first feedback signal V_{COMP_INT} at the first node N₁ coupled to the first end of the first capacitor 332.

When the power converter including the SSC 320 operates in the startup mode during a first time interval T₁ between the first time t₁ and a second time t₂, the soft-input generator 324, the gain adjusting circuit 330, and the voltage copier circuit 340 are disabled. As a result, the SSC 320 uses the first feedback path 382 including the transconductance amplifier 328 and the first capacitor 332. The capacitance value of the first capacitor 332 is relatively small, and thus the first feedback path 382 of the SSC 320 may have a relatively high gain value, leading to a relatively high bandwidth of a feedback loop of the power converter that includes the first feedback path 382 of the SSC 320, the feedback loop performing current regulation and power factor correction (PFC). For example, the capacitance value of the first capacitor 332 may be equal to or less than 10 pF. In an embodiment, the feedback loop speed or the bandwidth of the feedback loop may be sufficiently high to prevent an overshoot of the string current and a flickering during the first time interval T₁. For example, the bandwidth of the feedback loop may be higher than 10 kHz.

At the second time t₂, the power converter including the SSC 320 starts to operate in a second mode (e.g., a gain adjusting mode), and the gain adjusting circuit 330 and the voltage copier circuit 340 are activated in response to a gain control signal GC. In an embodiment, a timer circuit (not shown) in the SSC 320 includes a counter circuit that starts to increase its value at the first time t₁ when the power converter starts to operate in the start-up mode and asserts the gain control signal GC at the second time t₂ when the value reaches a first given value. The counter circuit further increases the value and de-asserts the gain control signal GC at a third time t₃ when the value reaches a second given value greater than the first given value. As a result, the SSC 320 uses the second feedback path 384 including the transconductance amplifier 328, the first capacitor 332, the gain adjusting circuit 330, the voltage copier circuit 340, and the second node N₂ coupled to the second capacitor 316.

When the power converter including the SSC 320 operates in the gain adjusting mode during a second time interval T₂ between the second time t₂ and the third time t₃, the gain adjusting circuit 330 decreases the gain value of the second feedback path 384 at a plurality of times. In an embodiment, the gain adjusting circuit 330 includes a plurality of resistors coupled in parallel, and a total resistance value of the gain adjusting circuit 330 decreases from a maximum value to a minimum value. As the total resistance value of the gain adjusting circuit 330 decreases during the second time interval T₂, an amount of a first portion of the output current from the transconductance amplifier 328 flowing into the second capacitor 316 increases whereas an amount of a second portion of the output current from the transconductance amplifier 328 flowing into the first capacitor 332 decreases. Because the capacitance value of the second capacitor 316 is significantly greater than that of the first capacitor 332, the gain value of the second feedback path 384 of the SSC 320 may gradually decrease during the second time interval T₂. As a result, an overshoot of the string current, or a flickering, or both may not occur during the second time interval T₂.

In an embodiment, the gain adjusting circuit 330 decreases the gain value of the second feedback path 384 at a predetermined number of times during the second time interval T₂. For example, referring to FIG. 4, the total resistance value of the gain adjusting circuit 430 decreases twelve times during the second time interval T₂, thereby decreasing the gain value of the second feedback path 384 twelve times during the second time interval T₂.

In an embodiment, the gain adjusting circuit 330 may decrease the total resistance value at regular time intervals. For example, the second time interval T₂ between the second time t₂ and the third time t₃ may have a duration of 500 ms, and the total resistance values of the gain adjusting circuit 430 in FIG. 4 may be decreased at regular intervals each having a duration of about 41.7 ms (=500 ms/12).

In an embodiment, the gain adjusting circuit 330 may substantially exponentially decrease its total resistance value during the second time interval T₂. For example, the total resistance values of the gain adjusting circuit 430 in FIG. 4 are 10 MΩ, 909 KΩ, 323 KΩ, 155 KΩ, 60.9 KΩ, 27.4 KΩ, 14.3 KΩ, 5.89 KΩ, 1.99 KΩ, 855Ω, 315Ω, and 0Ω when the switches S₁ to S₁₂ are sequentially turned on, respectively. However, embodiment of the present Application are not limited thereto. In other embodiments, the gain adjusting circuit 330 may substantially linearly decrease its total resistance value during the second time interval T₂. When the gain adjusting circuit 430 substantially exponentially decreases the total resistance value, the gain adjusting circuit 430 may include a smaller number of the resistors R₁ to Rₙ₋₁ compared to that when the gain adjusting circuit 430 substantially linearly decreases the total resistance value, thereby reducing a circuit area.

When the power converter including the SSC 320 operates in the gain adjusting mode during the second time interval T₂, the voltage copier circuit 340 copies the first feedback signal V_{COMP_INT} and provides an averaged version of the first feedback signal V_{COMP_INT} to the second node N₂ as the second feedback signal V_{COMP}. As a result, one or more fluctuations in the first feedback signal V_{COMP_INT} when the gain adjusting circuit 330 decreases the gain value of the second feedback path 384 at a plurality of times during the second time interval T₂ may be suppressed. For example, when each of the switches S₁ to S₁₂ of the gain adjusting circuit 430 in FIG. 4 is turned on, a fluctuation in the first feedback signal V_{COMP_INT} may be suppressed by providing the second feedback signal V_{COMP} to the second node N₂ using the voltage copier circuit 340. In an embodiment, the voltage copier circuit 340 includes a second buffer 338 and a filter 336. For example, the second buffer 338 has a unity gain and the filter 336 is a low-pass filter.

At the third time t₃, the power converter including the SSC 320 starts to operate in a third mode (e.g., a low-gain mode). The timer circuit 322 asserts the soft-start end signal SS_{END} at the third time t₃ to turn on the first switching device 342. In the embodiment shown in FIG. 5, the soft-start end signal SS_{END} is asserted at the third time t₃ and indicates an end of the gain adjusting mode. However, embodiments of the present disclosure are not limited thereto. For example, in another embodiment, the soft-start end signal SS_{END} is asserted at the second time t₂ and indicates an end of the startup mode.

After the third time t₃, the first switching device 342 is turned on and the soft-input generator 324 receives the external dimming signal V_{DIM_EXT} through the dimming pin Ext_DIM and generates an output signal in response to the external dimming signal V_{DIM_INT}. In an embodiment, the soft-input generator 324 gradually increases a value of the output signal until the value reaches a given value corresponding to that of the external dimming signal V_{DIM_INT}. As a result, the arithmetic circuit 326 gradually increases a value of the reference signal V_{CS_REF} in response to the output signal of the soft-input generator 324 and the internal dimming signal V_{DIM_INT}, rather than instantaneously increasing the value of reference signal V_{CS_REF} from a value of the internal dimming signal V_{DIM_INT} to the sum of the value of the internal dimming signal V_{DIM_INT} and the given value corresponding to the external dimming signal V_{DIM_INT}. As a result, an overshoot of the string current, or a flickering, or both may be suppressed after the third time t₃ when the timer circuit 322 asserts the soft-start end signal SS_{END} to turn on the first switching device 342. According to the embodiment shown in FIG. 5, the first switching device 342 is turned on at the third time t₃, and the soft-input generator 324 gradually increases the value of the output signal during a third time interval T₃ between the third time t₃ and a fourth time t₄ when the power converter including the SSC 320 operates in the low-gain mode. However, embodiments of the present disclosure are not limited thereto. For example, the first switching device 342 may be turned on the second time t₂, and the soft-input generator 324 may gradually increase the value of the output signal during the second time interval T₂ between the second time t₂ and the third time t₃ when the power converter including the SSC 320 operates in the gain adjusting mode.

During the third time interval T₃ between the third time t₃ and a the fourth time t₄, the transconductance amplifier 328 generates the first feedback signal V_{COMP_INT} having a value less than that during the second time interval T₂ between the second time t₂ and the third time t₃. In the embodiment shown in FIG. 3, the transconductance amplifier 328 has an inverting input receiving the reference signal V_{CS_REF} and a non-inverting input receiving the sensing signal V_{CS}. However, embodiments of the present disclosure are not limited thereto. For example, when an opto-coupler (not shown) is coupled to an output node (e.g., the output node No in FIG. 2), the transconductance amplifier 328 may have an inverting input receiving the sensing signal V_{CS} and a non-inverting input receiving the reference signal V_{CS_REF}. The gain adjusting circuit 330 is short-circuited, and thus generates the second feedback signal V_{COMP} having substantially the same value as that of the first feedback signal V_{COMP_INT}. The first buffer 334 generates the opto-coupler signal V_{PC} in response to the first feedback signal V_{COMP_INT}. For example, the first buffer 334 has a unity gain and generates the opto-coupler signal V_{PC} having substantially the same value as that of the first feedback signal V_{COMP_INT}. Because the first feedback signal V_{COMP_INT} during the third time interval T₃ has a value less than that during the second time interval T₂, the opto-coupler signal V_{PC} during the third time interval T₃ also has a value less than that during the second time interval T₂. As a result, a feedback current (e.g., the feedback current I_{FB} in FIG. 2) is decreased and the feedback voltage V_{FB} (e.g., the feedback voltage V_{FB} in FIG. 2) is increased during the third time interval T₃.

At the fourth time t₄, the sensing signal V_{CS} reaches to a second value V₂ corresponding to the value of the external dimming signal V_{DIM_INT}. As a result, the string current also reaches to a magnitude corresponding to the value of the external dimming signal V_{DIM_INT}.

When the power converter including the SSC 320 operates in the low-gain mode after the third time t₃, the SSC 320 uses the third feedback path 386 including the transconductance amplifier 328, the first capacitor 332, the gain adjusting circuit 330, and the second node N₂ coupled to the second capacitor 316. The capacitance value of the second capacitor 316 is significantly greater than that of the first capacitor 332, and thus the gain value of the third feedback path 386 may be determined predominantly according to the capacitance value of the second capacitor 316 and substantially independently of the capacitance value of the first capacitor 332. The capacitance value of the second capacitor 316 is relatively large, and thus the third feedback path 386 of the SSC 320 may have a relatively low gain value suitable for performing Power Factor Correction (PFC). In an embodiment, the gain value of the third feedback path 386 be sufficiently low to make the bandwidth of the feedback loop of the power converter including the SSC 320 lower than a line frequency (e.g., 60 Hz), the feedback loop including the third feedback path 386 and performing current regulation and power factor correction (PFC).

As described above, when a power converter including the SSC 320 according to an embodiment of the present disclosure operates in the high-gain mode (or the startup mode) during the first time interval T₁, the SSC 320 uses the first feedback path 382 with a relatively high gain value, thereby preventing an overshoot of the string current, or a flickering, or both during the first time interval T₁. When such a power converter operates in the gain adjusting mode during the second time interval T₂, the gain adjusting circuit 330 gradually decreases the gain value of the second feedback path 384, thereby preventing an overshoot of the string current, or a flickering, or both during the second time interval T₂. In addition, the voltage copier circuit 340 provides the second feedback signal V_{COMP} by copying the first feedback signal V_{COMP_INT}, thereby suppressing fluctuations in the feedback signal V_{COMP_INT} when the gain value of the second feedback path 384 decreases at a plurality of times during the second time interval T₂. When the power converter operates in the low-gain mode, the soft-input generator 324 receives the external dimming signal V_{DIM_INT}, and then gradually increases a value of its output signal in response to the received external dimming signal V_{DIM_INT}, thereby suppressing an overshoot of the string current, or a flickering, or both. As a result, an overshoot of the string current, or a flickering, or both may be substantially prevented when the power converter including the SSC 320 operates in the high-gain mode, the gain adjusting mode, and the low-gain mode.

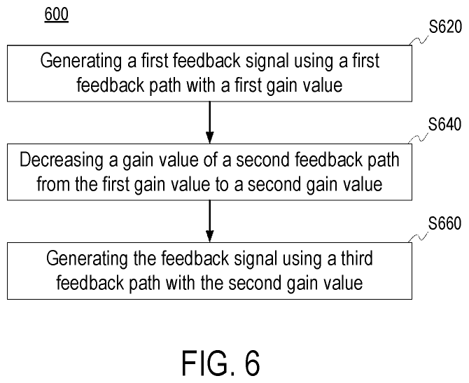

FIG. 6 illustrates a process 600 performed by a controller (e.g., the SSC 320 in FIG. 3) of a power converter (e.g., the flyback converter 200 in FIG. 2) according to an embodiment. In an embodiment, the controller includes a feedback signal generator (e.g., the feedback signal generator 380 in FIG. 3), and the feedback signal generator includes an amplifier (e.g., the transconductance amplifier 328 in FIG. 3), a first capacitor (e.g., the first capacitor 332 in FIG. 3) coupled to the amplifier at a first node (e.g., the first node N₁ in FIG. 3), a gain adjusting circuit (e.g., the gain adjusting circuit 330 in FIG. 3), and a second node (e.g., the second node N₂ in FIG. 3) at which a second capacitor (e.g., the second capacitor 316 in FIG. 3) is coupled to the gain adjusting circuit.

At S620, the controller generates a first feedback signal (e.g., the first feedback signal V_{COMP_INT}) in response to a sensing signal (e.g., the sensing signal V_{CS} in FIG. 3) and an external signal (e.g., the external dimming signal V_{DIM_EXT} in FIG. 3) using a first feedback path (e.g., the first feedback path 382 in FIG. 3) with a first gain value. In an embodiment, the feedback signal generator uses the first feedback path when the power converter operates in a first mode (e.g., the startup mode or the high-gain mode), and uses a second feedback path (e.g., the second feedback path 384 in FIG. 3) when the power converter operates in a second mode (e.g., the gain adjusting mode). For example, the first feedback path includes the amplifier and the first capacitor, and has the first gain value that is sufficiently high to prevent an overshoot of a string current, or a flickering, or both.

At S640, the controller decreases a gain value of a second feedback path from the first gain value to a second gain value at a plurality of times when the power converter operates in the gain adjusting mode, the second feedback path including the amplifier, the first capacitor, the gain adjusting circuit, the voltage copier circuit, and the second node coupled to the second capacitor. In an embodiment, the controller decreases a resistance value between the first node and the second node at a plurality of times when the power converter operates in the gain adjusting mode, thereby increasing an amount of a first portion of an output current from the amplifier flowing into the second capacitor while decreasing an amount of a second portion of the output current from the amplifier flowing into the first capacitor. A capacitance value of the second capacitor may be greater than that of the first capacitor, and thus the gain value of the second feedback path may decrease when the power converter operates in the gain adjusting mode. In an embodiment, the controller further includes a voltage copier circuit (e.g., the voltage copier circuit 340 in FIG. 3) that copies the first feedback signal, averages the copied first feedback signal to generate a second feedback signal (e.g., the second feedback signal V_{COMP} in FIG. 3), and provides the second feedback signal to the second node.

At S660, the controller generates the first feedback signal in response to the sensing signal and the external dimming signal using a third feedback path (e.g., the third feedback path 386 in FIG. 3) with the second gain value when the power converter operates in a third mode (e.g., the low-gain mode). In an embodiment, the third feedback path includes the amplifier, the first capacitor, and the second node coupled to the second capacitor when the power converter operates in the third mode, and has the second gain value that is sufficiently low to perform a PFC operation.

Aspects of the present disclosure have been described in conjunction with the specific embodiments thereof that are proposed as examples. Numerous alternatives, modifications, and variations to the embodiments as set forth herein may be made without departing from the scope of the claims set forth below. Accordingly, embodiments as set forth herein are intended to be illustrative and not limiting.

What is claimed is:

1. A controller for a power converter, the controller comprising:
a first input node receiving a sensing signal, the sensing signal indicting an output signal of the power converter;
a second input node receiving an external signal, the external signal indicating a target value for a load; and
a feedback signal generator configured to generate a first feedback signal in response to the sensing signal and the external signal, the feedback signal generator using a first feedback path with a first gain value when the power converter operates in a first mode and using a second feedback path when the power converter operates in a second mode, the feedback signal generator including a gain adjusting circuit configured to decrease a gain value of the second feedback path from the first gain value to a second gain value at a plurality of times when the power converter operates in the second mode.

2. The controller of claim 1, wherein each of the first feedback path and the second feedback path includes an amplifier, and the gain adjusting circuit is coupled to the amplifier at a first node, and
wherein the feedback signal generator further includes a voltage copier circuit coupled to the gain adjusting circuit at a second node, the voltage copier circuit being configured to generate a second feedback signal in response to the first feedback signal and provide the second feedback signal to the second node when the power converter operates in the second mode.

3. The controller of claim 2, wherein the voltage copier circuit includes:
a buffer configured to copy the first feedback signal; and
a filter configured to generate an averaged version of the copied first feedback signal.

4. The controller of claim 2, wherein the gain adjusting circuit decreases the gain value of the second feedback path by decreasing a total resistance value of the gain adjusting circuit at the plurality of times.

5. The controller of claim 4, wherein the gain adjusting circuit includes a plurality of parallel paths between the first node and the second node, one of the plurality of paths including a first switching element, the remaining ones of the plurality of paths including a second plurality of switching elements and a plurality of resistors, respectively, each of the second plurality of switching elements being coupled to a respective one of the plurality of resistors in series.

6. The controller of claim 5, wherein the controller sequentially turns on the second plurality of switching elements and the first switching element of the gain adjusting circuit at regular intervals.

7. The controller of claim 2, wherein each of the first feedback path and the second feedback paths further includes a first capacitor coupled to the amplifier at the first node,
wherein the second feedback path further includes the second node at which a second capacitor is coupled to the gain adjusting circuit, and
wherein the second capacitor has a capacitance value that is greater than that of the first capacitor.

8. The controller of claim 7, wherein the capacitance value of the second capacitor is at least 10000 times greater than that of the first capacitor.

9. The controller of claim 8, wherein the capacitance value of the second capacitor is in a range from 100 nF to 5 μF and that of the first capacitor is equal to or less than 10 pF.

10. The controller of claim 1, further comprising:
a soft-input generator configured to generate an output signal in response to a soft-start end signal, the soft-start end signal indicating either an end of the first mode or an end of the second mode; and
a switching device configured to couple a pin that receives the external signal to the soft-input generator in response to the soft-start end signal.

11. The controller of claim 10, further comprising an arithmetic circuit configured to generate a refence signal in response to an internal dimming signal and the output signal from the soft-input generator,
wherein the feedback signal generator includes an amplifier, the amplifier generating the first feedback signal in response to the reference signal and the sensing signal.

12. The controller of claim 1, wherein the first gain value is sufficient to make a bandwidth of a feedback loop of the power converter higher than 10 kHz, and the second gain value is sufficient to make the bandwidth of the feedback loop less than 60 Hz.

13. A method for controlling a power converter, the method comprising:
generating a first feedback signal in response to a sensing signal and an external signal by a feedback signal generator, the feedback signal generator using a first feedback path with a first gain value when the power converter operates in a first mode and using a second feedback path when the power converter operates in a second mode, the sensing signal indicting an output signal of the power converter, the external signal indicating a target value for a load; and
decreasing a gain value of the second feedback path from the first gain value to a second gain value at a plurality of times when the power converter operates in the second mode.

14. The method of claim 13, wherein each of the first feedback path and the second feedback path includes an amplifier and a first capacitor, the amplifier being coupled to the first capacitor at a first node, the second feedback path further including a second node coupled to a second capacitor, the second capacitor having a capacitance value greater than that of the first capacitor, the method further comprising:
decreasing a resistance value between the first node and the second node at the plurality of times when the power converter operates in the second mode.

15. The method of claim 14, further comprising:
copying the first feedback signal;
averaging the copied first feedback signal to generate a second feedback signal; and
providing the second feedback signal to the second node.

16. The method of claim 14, wherein a plurality of parallel paths are disposed between the first node and the second node, one of the plurality of paths including a first switching element, the remaining ones of the plurality of paths including a second plurality of switching elements and a plurality of resistors, respectively, each of the second plurality of switching elements being coupled to a respective one of the plurality of resistors in series, and
wherein decreasing the resistance value between the first node and the second node comprises sequentially turning on the second plurality of switching elements and the first switching element at regular intervals.

17. The method of claim 14, wherein the capacitance value of the second capacitor is at least 10000 times greater than that of the first capacitor.

18. A power converter, comprising:
a first side including a first controller and a first portion of an opto-coupler, the first controller controlling a switching operation of a switching device; and
a second side including a second controller and a second portion of the opto-coupler, the second controller including:
a feedback signal generator configured to generate a first feedback signal in response to a sensing signal and an external signal, the sensing signal indicting an output signal of the power converter, the external signal indicating a target value for a load, the feedback signal generator using a first feedback path with a first gain value when the power converter operates in a first mode and using a second feedback path when the power converter operates in a second mode, the feedback signal generator including a gain adjusting circuit configured to decrease a gain value of the second feedback path from the first gain value to a second gain value at a plurality of times when the power converter operates in the second mode; and
a buffer configured to generate an opto-coupler signal in response to the first feedback signal and provide the opto-coupler signal to the second portion of the opto-coupler.

19. The power converter of claim 18, wherein each of the first feedback path and the second feedback path includes an amplifier, and the gain adjusting circuit is coupled to the amplifier at a first node, and
wherein the feedback signal generator further includes a voltage copier circuit coupled to the gain adjusting circuit at a second node, the voltage copier circuit being configured to generate a second feedback signal in response to the first feedback signal and provides the second feedback signal to the second node when the power converter operates in the second mode.

20. The power converter of claim 19, wherein each of the first feedback path and the second feedback paths further includes a first capacitor coupled to the amplifier at the first node,
wherein the second feedback path further includes the second node at which a second capacitor is coupled to the gain adjusting circuit, and
wherein the second capacitor has a capacitance value that is greater than that of the first capacitor.
